(19) United States
(12) Patent Application Publication
(10) Pub. No.: US 2011/0063197 A1
(43) Pub. Date: Mar. 17, 2011

(54) PIXEL CIRCUIT AND ORGANIC LIGHT EMITTING DISPLAY APPARATUS INCLUDING THE SAME

(76) Inventors: Bo-Yong Chung, Yongin-city (KR); Keum-Nam Kim, Yongin-city (KR)

(21) Appl. No.: 12/716,134

(22) Filed: Mar. 2, 2010

(30) Foreign Application Priority Data
Sep. 14, 2009 (KR) 10-2009-0086662

(51) Int. Cl. G09G 3/32

(52) U.S. Cl. 345/82

(57) ABSTRACT

A pixel circuit includes: a second NMOS transistor coupled to a data line and a scan line, the second NMOS transistor for supplying data signals to a first node; a capacitor having a first terminal coupled to the first node and a second terminal coupled to a second node; an OLED having a first terminal coupled to the second node and a second terminal coupled to a second power source; a first NMOS transistor including a first electrode, a second electrode, and a gate electrode coupled to the first node, and for supplying a current corresponding to a voltage applied to the first node from a first power source to the second power source via the OLED; and a third NMOS transistor coupled to the first NMOS transistor in series and configured to be turned on when a light emission control signal is supplied from a light emission control line.

### CROSS-REFERENCE TO RELATED PATENT APPLICATION

This application claims priority to and the benefit of Korean Patent Application No. 10-2009-0086662, filed on Sep. 14, 2009, in the Korean Intellectual Property Office, the disclosure of which is incorporated herein in its entirety by reference.

### BACKGROUND

1. Field

An aspect of an embodiment of the present invention relates to a pixel circuit and an organic light emitting display apparatus using the pixel circuit.

2. Description of Related Art

Flat panel display apparatuses such as liquid crystal displays (LCDs), plasma display panels (PDPs), and field emission displays (FEDs), which may address the problems of cathode ray tubes (CRTs), have been developed. Among the flat panel display apparatuses, organic light emitting display apparatuses have excellent light emitting efficiency, high brightness, wide viewing angle, and fast response speed.

The organic light emitting displays display images by using organic light emitting diodes (OLEDs) that generate light by recombining electrons and holes with a low power consumption and fast response speed.

### SUMMARY

An aspect of an embodiment of the present invention provides a pixel circuit and an organic light emitting display using the pixel circuit.

According to an embodiment of the present invention, there is provided a pixel circuit of an organic light emitting display. The pixel circuit including: a second N-channel metal oxide semiconductor (NMOS) transistor coupled to data lines and scan lines for supplying data signals to a first node; a storage capacitor having a first terminal coupled to the first node and a second terminal coupled to a second node; an organic light emitting diode (OLED) having a first terminal coupled to the second node and a second terminal coupled to a second power source; a first NMOS transistor including a first electrode, a second electrode, and a gate electrode coupled to the first node, and for supplying a current corresponding to a voltage applied to the first node from a first power source to the second power source via the OLED; and a third NMOS transistor coupled to the first NMOS transistor in series and configured to be turned on when a light emission control signal is supplied from a light emission control line.

The first electrode of the first NMOS transistor may be a drain electrode and the second electrode of the first NMOS transistor may be a source electrode, and the second electrode of the first NMOS transistor may be coupled to the second node.

The third NMOS transistor may include: a gate electrode coupled to a light emission control line; a first electrode coupled to the first power source; and a second electrode coupled to the first electrode of the first NMOS transistor.

The third NMOS transistor may include: a gate electrode coupled to a light emission control line; a first electrode coupled to the second electrode of the first NMOS transistor; and a second electrode coupled to the second node.

The second NMOS transistor may be configured to be turned on when a scan signal is supplied from the scan line.

The pixel circuit may further include a third power source for applying a reference voltage to the second node.

The first power source may be configured to apply a first voltage, and the second power source may be configured to apply a second voltage that is lower than the first voltage.

According to another embodiment of the present invention, there is provided an organic light emitting display apparatus including: a first scan driver coupled to light emission control lines for supplying light emission control signals; a second scan driver coupled to scan lines for supplying scan signals; a data driver coupled to data lines for supplying data signals; and a display unit including a plurality of pixel circuits coupled to the scan lines, the light emission control lines, and the data lines, wherein the pixel circuits each include: a second N-channel metal oxide semiconductor (NMOS) transistor for supplying a corresponding one of the data signals to a first node, the second NMOS transistor coupled to a corresponding one of the data lines and a corresponding one of the scan lines; a storage capacitor having a first terminal coupled to the first node, and a second terminal coupled to a second node; an organic light emitting diode (OLED) having a first terminal coupled to the second node and a second terminal coupled to a second power source; a first NMOS transistor including a first electrode, a second electrode, and a gate electrode coupled to the first node, and for supplying a current corresponding to a voltage applied to the first node from a first power source to the second power source via the OLED; and a third NMOS transistor coupled to the first NMOS transistor in series and configured to be turned on when a light emission control signal is supplied from a corresponding one of the light emission control lines.

The first electrode of the first NMOS transistor may be a drain electrode and the second electrode of the first NMOS transistor may be a source electrode, and the second electrode of the first NMOS transistor may be coupled to the second node.

The third NMOS transistor may include: a gate electrode coupled to a corresponding one of the light emission control lines; a first electrode coupled to the first power source; and a second electrode coupled to the first electrode of the first NMOS transistor.

The third NMOS transistor may include: a gate electrode coupled to the corresponding light emission control line; a first electrode coupled to the second electrode of the first NMOS transistor; and a second electrode coupled to the second node.

The second NMOS transistor may be configured to be turned on when a corresponding one of the scan signals is supplied from a corresponding one of the scan lines.

The organic light emitting display apparatus may further include a third power source for applying a reference voltage to the second node.

The first power source may be configured to apply a first voltage, and the second power source may be configured to apply a second voltage that is lower than the first voltage.

### BRIEF DESCRIPTION OF THE DRAWINGS

The above and other features and aspects of embodiments of the present invention will become more apparent by describing in detail exemplary embodiments thereof with reference to the attached drawings in which:

FIG. 1 is a schematic diagram of an organic light emitting diode (OLED);

FIG. 2 is a circuit diagram of a voltage driving type pixel circuit;

FIG. 3 is a block diagram of an organic light emitting display according to an embodiment of the present invention;

FIG. 4 is a circuit diagram of one of a plurality of pixel circuits included in the organic light emitting display of FIG. 3, according to an embodiment of the present invention;

FIG. 5 is a timing diagram of the pixel circuit of FIG. 4 according to an embodiment of the present invention;

FIGS. 6 and 7 are circuit diagrams showing operations of the pixel circuit of FIG. 4 according to the timing diagram of FIG. 5;

FIG. 8 is a diagram illustrating characteristics of the organic light emitting display according to an embodiment of the present invention;

FIG. 9 is a circuit diagram of a modified example of the pixel circuit of FIG. 4 according to an embodiment of the present invention;

FIG. 10 is a diagram illustrating characteristics of the organic light emitting display according to an embodiment of the present invention;

FIG. 11 is a circuit diagram of a pixel circuit included in the organic light emitting display of FIG. 3, according to another embodiment of the present invention; and

FIGS. 12 and 13 are circuit diagrams illustrating operations of the pixel circuit of FIG. 8 according to the timing diagram of FIG. 5.

### DETAILED DESCRIPTION

Hereinafter, the present invention will be described in detail by explaining embodiments of the invention with reference to the attached drawings. Like reference numerals in the drawings denote like elements.

In general, an organic light emitting display apparatus emits light by exciting a phosphorous organic compound, and displays images by voltage-driving or current-driving a plurality of organic light emitting cells arranged in a matrix, wherein the organic light emitting cells include OLEDs.

FIG. 1 is a schematic diagram showing an OLED.

Referring to FIG. 1, the OLED includes an anode layer (e.g., indium tin oxide (ITO)), an organic thin film, and a cathode layer (e.g., metal). The organic thin film includes an emission layer (EML), an electron transport layer (ETL), and a hole transport layer (HTL) for balancing electrons and holes in order to improve a light emitting efficiency of the OLED. Besides, the organic thin film may further include a hole injecting layer (HIL) or an electron-injecting layer (EIL).

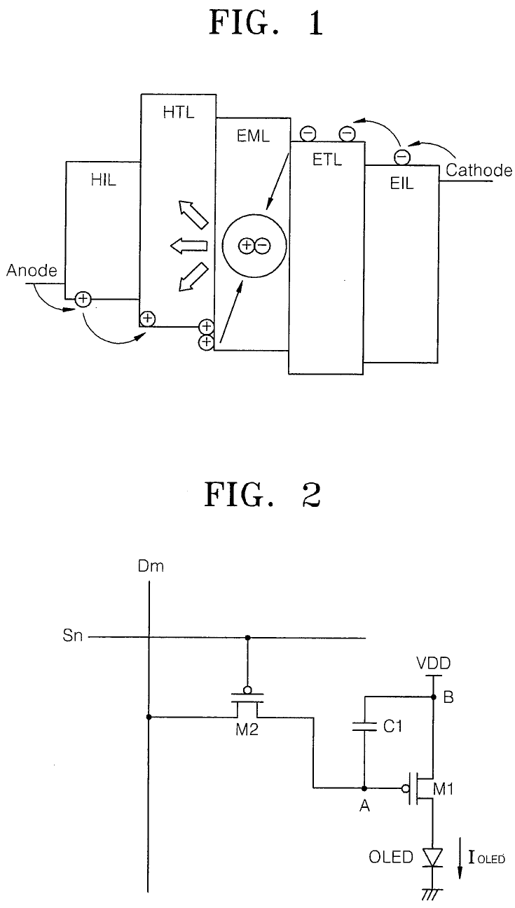

FIG. 2 is a circuit diagram of a pixel circuit including P-channel metal oxide semiconductor (PMOS) transistors.

Referring to FIG. 2, the pixel circuit includes a switching transistor M2, which is connected to a data line Dm and a scan line Sn to supply data signals to a node A, a capacitor C1 having a first terminal connected to the node A and a second terminal connected to a voltage source VDD, a driving transistor M1 having a gate electrode connected to the node A, a first electrode connected to the voltage source VDD, and a second electrode connected to an OLED, and the OLED. Here, the driving transistor M1 is a PMOS transistor, and thus the first electrode is a source of the PMOS transistor, and the second electrode is a drain of the PMOS transistor.

The switching transistor M2 is turned on by a selection signal applied to the scan line Sn, and then, a data voltage is applied from the data line Dm to the gate of the driving transistor M1. In addition, a potential difference between the data voltage and the voltage of the voltage source VDD is stored in the capacitor C1 connected between the gate and the source electrode of the driving transistor M1. A driving current I_{OLED} flows through the OLED due to the potential difference to emit light from the OLED. Here, a brightness gradation (e.g., a predetermined brightness gradation) may be represented according to an applied data voltage.

Referring to the pixel circuit shown in FIG. 2, the switching transistor M2 and the driving transistor M1 are PMOS transistors. The second terminal of the capacitor C1 is connected to the voltage source VDD, and the first terminal of the capacitor C1 is connected to the node A.

In this case, the driving transistor M1 operates as a current source. The data voltage is applied to the gate electrode of the driving transistor M1, and the voltage source VDD applies a voltage to the source electrode of the driving transistor M1. That is, since the source electrode of the driving transistor M1 is fixed at the VDD voltage, the voltage does not affect a voltage difference Vgs between voltages of the gate and source electrodes of the driving transistor M1 when the OLED emits light.

The switching transistor M2 and the driving transistor M1 of FIG. 2 may be formed of N-channel metal oxide semiconductor (NMOS) transistors, and a switching transistor M3 which is connected to the driving transistor M1 in series to operate according to a light emission control signal may be additionally formed. In this case, the capacitor C1 is connected between the gate and the drain electrodes of the driving transistor M1.

When the pixel circuit of FIG. 2 is formed using the NMOS transistors, a voltage at the source electrode of the driving transistor M1 is determined by a voltage of the anode in the OLED. That is, the voltage at the source electrode of the driving transistor M1 is not fixed, and a source follower type configuration, in which a load is connected to the source electrode, is formed. Thus, the pixel circuit formed of the NMOS transistors is sensitively affected by the voltage change at the anode of the OLED when the switching transistor M3 is turned on by the light emission control signal in order to turn on the OLED. In addition, when the gate voltage of the driving transistor M1 increases, the current flowing through the driving transistor M1 also increases. Therefore, voltages at both the anode and cathode of the OLED increase. Since the OLED is connected to the source electrode of the driving transistor M1, the voltage at the source electrode of the driving transistor M1 increases. Therefore, a voltage difference Vgs between voltages of the gate and source electrodes of the driving transistor M1 is reduced.

Therefore, in the pixel circuit having the capacitor C1 that is connected to the gate and drain electrodes of the driving transistor M1, the voltage of the OLED that emits light affects the voltage difference Vgs. Thus, the pixel circuit is inevitably sensitive to changes in characteristics of the OLED due to factors such as temperature and deterioration of the OLED.

In addition, since the voltage of the OLED that emits light is also affected by a ELVSS voltage, a magnitude of the ELVSS voltage is changed by an IR voltage drop due to a parasitic resistance of a wire connecting the cathode electrode to the ELVSS voltage and a voltage drop due to currents flowing through each of the pixels. Consequently, the pixel circuit formed by using the NMOS transistors has an unstable voltage at the source electrode of the driving transistor M1, and thus a brightness of the emitted light may be inconsistent.

Hereinafter, one or more embodiments of the present invention will be described in more detail with reference to the accompanying drawings. Like reference numerals denote like elements in the drawings, and any repeated description thereof is omitted.

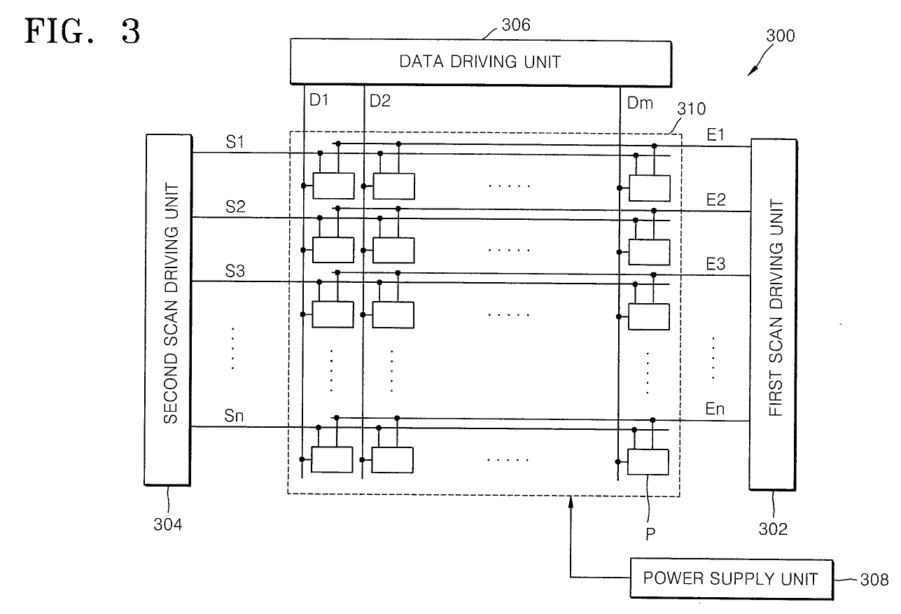

FIG. 3 is a block diagram of an organic light emitting display 300 according to an embodiment of the present invention.

Referring to FIG. 3, the organic light emitting display 300 according to one embodiment includes a display unit 310, a first scan driving unit 302, a second scan driving unit 304, a data driving unit 306, and a power supply unit 308.

The display unit 310 includes n×m pixel circuits P, (where n and m are positive integers) each of which includes an organic light emitting diode (OLED), n scan lines S1, S2, . . . , Sn extending in a first direction as rows for transmitting scan signals, m data lines D1, D2, . . . , Dm extending in a second direction different from the first direction as columns for transmitting data signals, n light emission control lines E1, E2, . . . , En extending in the first direction as rows for transmitting light emission control signals, and m first power lines and second power lines for applying voltages to the display unit 310.

The display unit 310 displays images by emitting light using the OLEDs according to the scan signals, the data signals, the light emission control signals, and the first power source ELVDD and the second power source ELVSS.

The first scan driving unit 302 is connected to the light emission control lines E1, E2, . . . , En to apply the light emission control signals to the display unit 310.

The second scan driving unit 304 is connected to the scan lines S1, S2, . . . , Sn to apply the scan signals to the display unit 310.

The data driving unit 306 is connected to the data lines D1, D2, . . . , Dm to apply data signals to the display unit 310. Here, the data driving unit 306 supplies data currents to the pixel circuits P during programming.

The power supply unit 308 applies the first power source ELVDD and the second power source ELVSS to each of the pixel circuits P.

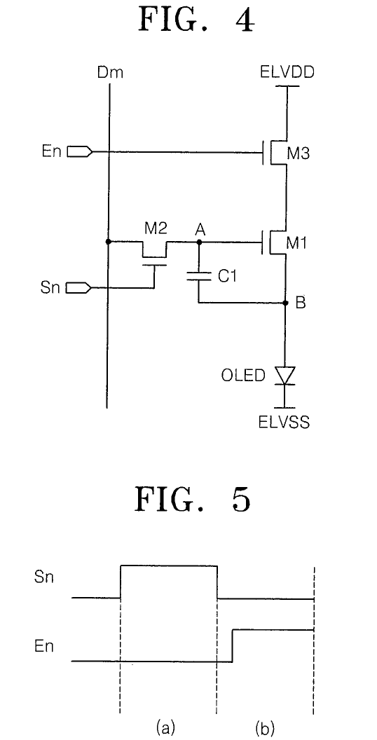

FIG. 4 is a circuit diagram of one of the pixel circuits P included in the organic light emitting display 300 illustrated in FIG. 3, according to an embodiment of the present invention.

In FIG. 4, for the convenience of description, the m-th data line Dm, the n-th scan line Sn, and the n-th light emission control line En are connected to the pixel circuit P.

Referring to FIG. 4, the pixel circuit P, according to one embodiment, includes an OLED, first through third NMOS transistors M1, M2, and M3 connected to the data line Dm, the scan line Sn, and the light emission control line En to control an amount of electric current supplied to the OLED, and a storage capacitor C1.

The OLED emits light with a brightness (e.g., a predetermined brightness) in correspondence to the amount of current supplied from the pixel circuit P. An anode of the OLED is connected to a node B, and a first terminal of the storage capacitor C1 and a second electrode of the first NMOS transistor M1, which is a driving transistor, are connected to the node B. A cathode of the OLED is connected to a second power source ELVSS. Here, a voltage of the second power source ELVSS may be much smaller than that of the first power source ELVDD. In addition, the first power source ELVDD may apply a high voltage, and the second power source ELVSS may apply a low voltage. In one embodiment, the second power source ELVSS may be set at a ground voltage (GND).

An NMOS transistor included in the pixel circuit P includes a first electrode, the second electrode, and a gate electrode. The NMOS transistor is turned off when a control signal applied at its gate electrode is at a low voltage, and turned on when the control signal is at a high voltage.

The NMOS transistor has a faster operational speed than the PMOS transistor. That is, electrons have higher mobility than holes, and an N-type transistor uses the electrons as carriers. Thus, the NMOS transistor has a faster response speed to the driving signal than a P-type transistor that uses the holes as the carriers.

Amorphous-silicon (Si) transistor fabrication processes may be performed at lower costs than those of poly-Si transistor fabrication processes. In addition, since a poly-Si transistor fabrication process is performed at a higher temperature than an amorphous-Si process, it is easier to fabricate the transistor by using the amorphous-Si. However, when the transistor is formed of the amorphous-Si, a pixel circuit only includes NMOS transistors due to characteristics of the amorphous-Si.

A gate electrode of the first NMOS transistor M1 is connected to the node A, and the first electrode of the first NMOS transistor M1, which is a drain electrode, is connected to the third NMOS transistor M3. The second electrode of the first NMOS transistor M1 is a source electrode that is connected to the anode (the node B) of the OLED. The first NMOS transistor M1 supplies the current corresponding to the voltage applied to the node A from the first power source ELVDD to the second power source ELVSS via the OLED.

A first electrode of the second NMOS transistor M2 is connected to the data line Dm, a second electrode of the second NMOS transistor M2 is connected to the node A, and a gate electrode of the second NMOS transistor M2 is connected to the n-th scan line Sn so as to transmit the data signal to the node A when the scan signal is applied to the gate electrode of the second NMOS transistor M2 from the n-th scan line Sn.

A first terminal of the storage capacitor C1 is connected to the node A, and a second terminal of the storage capacitor C1 is connected to the node B.

A first electrode of the third NMOS transistor M3 is connected to the first power source ELVDD, a second electrode of the third NMOS transistor M3 is connected to the first electrode of the first NMOS transistor M1, and a gate electrode of the third NMOS transistor M3 is connected to the n-th light emission control line En to be turned on when the light emission control signal is transmitted from the n-th light emission control line En.

Operations of driving the pixel circuit P shown in FIG. 4 will be described in more detail with reference to the timing diagram of FIG. 5.

Referring to FIG. 5, a first period (a) of FIG. 5 is a time period for initializing the pixel circuit P, compensating for a threshold voltage of the driving transistor, and writing data in the storage capacitor C1. In the first period (a), the n-th scan signal is at the high voltage. Next, a second period (b) of FIG. 5 is a time period in which the OLED emits light, and the n-th light emission control signal is at the high voltage.

Operations of driving a pixel circuit according to each period in the timing diagram of FIG. 5 will be described in detail as follows.

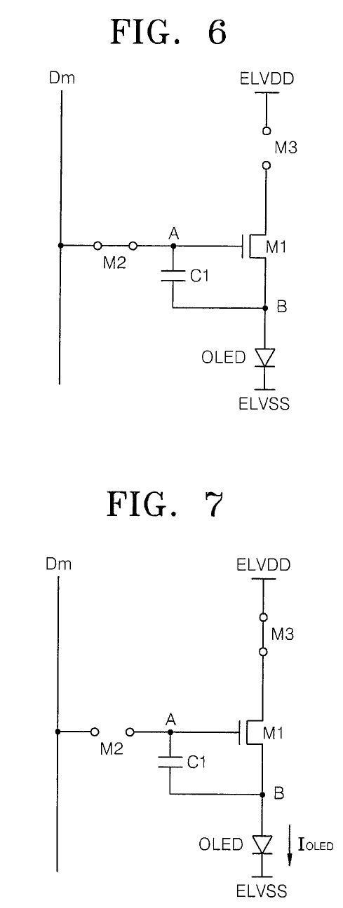

FIG. 6 illustrates the operation of the pixel circuit in the first period (a) of FIG. 5, and FIG. 7 illustrates the operation of the pixel circuit in the second period (b) of FIG. 5.

In the first period (a) of FIG. 5, the pixel circuit has a connection configuration as shown in FIG. 6. Referring to the timing diagram of FIG. 5, the n-th scan signal is applied to the pixel circuit in the first period (a) of FIG. 5.

Therefore, the second NMOS transistor M2 is turned on, and the data voltage is applied to the storage capacitor C1. Here, the voltage at the node A is the data voltage Vdata. A voltage corresponding to the threshold voltage of the OLED is applied to the node B. A voltage corresponding to a difference between the voltages at the node B and the node A is applied to the storage capacitor C1. In addition, since the light emission control signal is not applied to the pixel circuit in the first period (a), the third NMOS transistor M3 is in the turn-off state.

FIG. 7 shows a connection configuration of the pixel circuit in the second period (b) of FIG. 5. Referring to the timing diagram of FIG. 5, the n-th light emission control signal is applied to the pixel circuit in the second period (b).

Therefore, the third NMOS transistor M3 is turned on, and the first power source ELVDD is applied to the first electrode of the first NMOS transistor (driving transistor) M1. However, the n-th scan signal of a low voltage is applied to the gate electrode of the second NMOS transistor M2, and thus the second NMOS transistor M2 is turned off and the data signal transmitted from the data line Dm is not transmitted to the node A. The first NMOS transistor (driving transistor) M1 is turned on by the data signal transmitted to the storage capacitor C1 so that the voltage of the first power source ELVDD may be applied to the node B. The OLED is turned on by the voltage of the first power source ELVDD that is applied to the node B, and a current path is formed via the third NMOS transistor M3, which is turned on by the light emission control signal, the first and second electrodes of the first NMOS transistor M1, the node B, and the anode and the cathode of the OLED to the second power source ELVSS. Here, the second power source ELVSS may be at the ground voltage (GND).

When the OLED emits light, the voltage at the node A becomes Vdata−Vto+Voled+ELVSS in consideration of the voltage of the OLED that emits light. Here, the voltage at the node B is Voled+ELVSS. Where Voled is the voltage across the OLED while it is emitting light.

Therefore, the voltage Vgs of the first NMOS transistor M1 is expressed by the following Equation 1.

Vgs=(Vdata−Vto+Voled+ELVSS)−(Voled+ELVSS)=Vdata−Vto Equation 1

where Vdata denotes the data voltage, Voled denotes the voltage of the OLED that emits light, Vto denotes the threshold voltage of the OLED, and ELVSS denotes the voltage of the second power source.

The current flowing through the OLED may be expressed by the following Equation 2.

Ioled=K(Vgs−Vth)²=K{(Vdata−Vto)−Vth}² Equation 2

where loled denotes the current flowing through the OLED, K=β/2, K denotes a constant, and β denotes a gain factor.

According to the above Equation 2, the current flowing through the OLED is determined without regarding the voltage Voted of the OLED that emits light.

Here, the voltage Voted includes a voltage variation due to the ELVSS voltage drop, a variation in the characteristics of the OLED, and a change in current-voltage characteristics due to temperature change. In addition, the voltage Voled is related to the deterioration of the OLED. According to one embodiment of the present invention, the storage capacitor C1 is connected to the gate and source electrodes of the first NMOS transistor (driving transistor) M1, and thus influences of the voltage Voled on the current flowing through the OLED may be reduced. That is, since the influence of the voltage Voled on the current is removed, the influence of the variation in the voltage Voled due to the ELVSS voltage drop on the light emission is minimized or reduced, and the influences of the variation in the characteristics of the OLED, of the change in current-voltage characteristics due to temperature change, and of the deterioration of the OLED in light emission may be minimized or reduced.

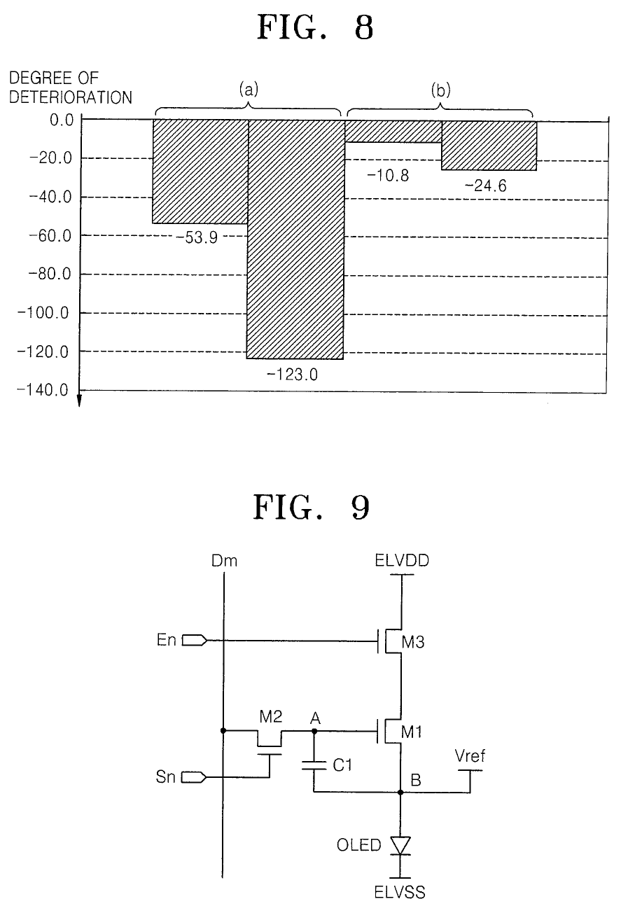

Referring to the diagram of FIG. 8, it shows that the pixel circuit of the above described embodiment is less sensitive to the deterioration of the OLED according to the results of simulated changes in the current-voltage characteristics of the OLED. Bars (a) of FIG. 8 show a case where the storage capacitor C1 is connected to the gate and drain electrodes of the driving transistor M1, and bars (b) of FIG. 8 show a case where the storage capacitor C1 is connected between the gate electrode and the source electrode (coupled to anode of the OLED) of the driving transistor M1. As the results of the simulation show, the pixel circuit of FIG. 8(b) is less sensitive to the deterioration of the OLED.

FIG. 9 is a circuit diagram of a pixel circuit according to another embodiment of the present invention.

The pixel circuit shown in FIG. 9 is a modified example of the pixel circuit P shown in FIG. 4, and is different from the pixel circuit P of FIG. 4 in that a reference voltage Vref is applied to the node B. Other elements and operations of the pixel circuit shown in FIG. 9 are the same as or similar to those of the pixel circuit P shown in FIG. 4, and thus detailed descriptions thereof are not provided here.

Here, the reference voltage Vref is a voltage at which the OLED is not turned on.

Referring to FIG. 5, the n-th scan signal is applied to the pixel circuit in the first period (a) to turn the second NMOS transistor M2 on and to write the data voltage to the storage capacitor C1. Here, the voltage at the node A is Vdata. In addition, the voltage at the node B is the reference voltage Vref that is applied to the node B. A voltage corresponding to a difference between the voltages of the node B and the node A is written in the storage capacitor C1.

In the second period (b), the n-th light emission control signal is applied to the pixel circuit, and the third NMOS transistor M3 is turned on. Then, the first power source ELVDD is applied to an electrode of the first NMOS transistor (driving transistor) M1. In addition, the first NMOS transistor M1 is turned on by the data signal applied to the storage capacitor C1 so that the voltage of the first power source ELVDD is applied to the node B. Thus, a current path through the OLED is formed. When the OLED emits light, the voltage at the node A becomes (Vdata−Vref)+(Voled+ELVSS) in consideration of the voltage Voled of the OLED that emits light. Here, the voltage at the node B is Voled+ELVSS.

Therefore, the voltage Vgs may be expressed by the following Equation 3.

Vgs=(Vdata−Vref+Voled+ELVSS)−(Voled+ELVSS)=Vdata−Vref Equation 3

where Vref denotes the reference voltage.

In addition, the current flowing through the OLED may be expressed by the following equation 4.

Ioled=K(Vgs−Vth)²=K{(Vdata−Vto)−Vth}² Equation 4

where loled denotes the current flowing in the OLED, K=β/2, K denotes a constant, and β denotes a gain factor.

According to Equation 4, the current flowing through the OLED is determined regardless of the voltage Voled of the OLED that emits light, the voltage of the second power source ELVSS, and the threshold voltage Vto of the OLED.

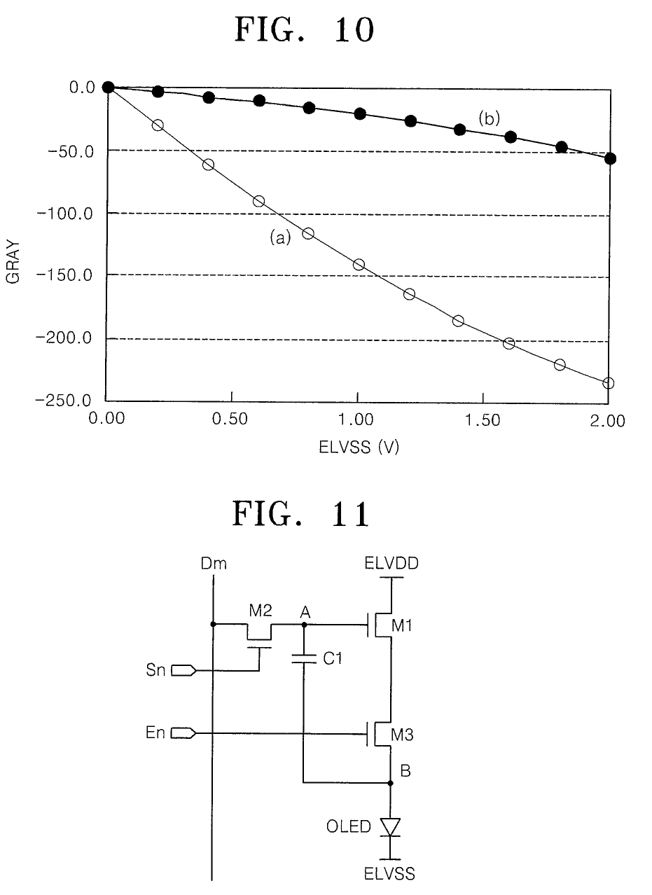

A gray level error when the voltage of the second power source ELVSS is changed while the threshold voltage of the OLED is fixed at a constant voltage will be described with reference to FIG. 10. Referring to FIG. 10, a curvature of curve (b), which is a result when the storage capacitor C1 is connected to the gate and source electrodes of the first NMOS transistor M1 according to one embodiment, is smaller than that of curve (a), which is a result when the storage capacitor C1 is connected to the gate and drain electrodes of the first NMOS transistor M1. Thus, the gray level error of curve (b) is less than that of curve (a) with respect to the same voltage change of the second power source ELVSS. As described above, the smaller gray level error means that the amount of current flowing through the OLED of the pixel circuit is changed less. Therefore, according to the above-described embodiment, the amount of current flowing through the OLED is not significantly changed even when the voltage of the second power source ELVSS is changed, and thus the gray level of the emitted light may be represented with a substantially constant brightness characteristic.

FIG. 11 is a circuit diagram of a pixel circuit according to another embodiment of the present invention.

Elements in FIG. 11 that are the same as those of the pixel circuit illustrated in FIG. 4 perform the same or similar functions, and accordingly, detailed descriptions thereof are not provided.

The pixel circuit of FIG. 11 is different from the pixel circuit described with reference to FIG. 4 and FIG. 5 in that the third NMOS transistor M3 is connected between the gate electrode of the first NMOS transistor M1 and the node B. Other elements and operations are the same as those of the pixel circuit illustrated in FIG. 4, and thus detailed descriptions thereof are not provided here.

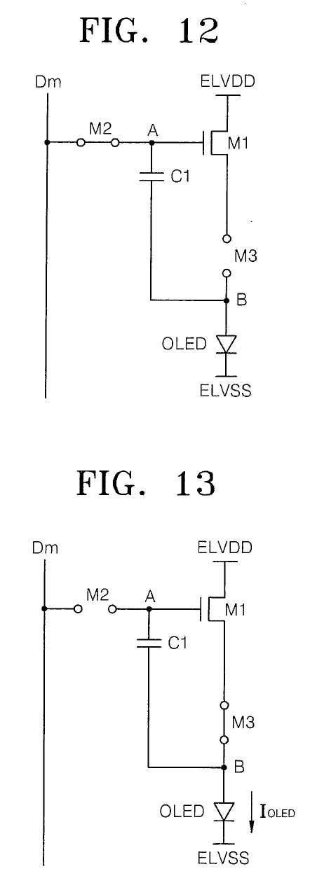

In the first period (a) of FIG. 5, the pixel circuit of FIG. 11 has a connection configuration shown in FIG. 12. The n-th scan signal is applied to the pixel circuit in the first period (a) of FIG. 5. Therefore, the second NMOS transistor M2 is turned on, and the data voltage is applied to the storage capacitor C1. In addition, since the light emission control signal is not applied to the pixel circuit in the first period (a) of FIG. 5, the third NMOS transistor M3 is in the turn-off state.

In the second period (b) of FIG. 5, the pixel circuit of FIG. 11 has a connection configuration shown in FIG. 13. In the second period (b) of FIG. 5, the n-th light emission control signal is applied to the pixel circuit, and thus the third NMOS transistor M3 is turned on. The first NMOS transistor (driving transistor) M1 is turned on by the data signal applied to the storage capacitor C1, and thus the voltage of the first power source ELVDD is applied to the node B via the third NMOS transistor M3, which is in the turn-on state. The OLED emits light due to the current flowing through the current path from the first power source ELVDD to the second power source ELVSS. When the OLED emits light, the voltage at the node A becomes Vdata−Vto+Voled+ELVSS in consideration of the voltage Voled of the OLED that emits light. Here, the voltage at the node B is Voled+ELVSS.

Thus, the current flowing through the OLED may be expressed by the following Equation 5.

Ioled=K(Vgs−Vth)²=K{(Vdata−Vto)−Vth}² Equation 5

where loled denotes the current flowing through the OLED, K=β/2, K denotes a constant, and β denotes a gain factor.

According to Equation 5, the current flowing through the OLED is determined regardless of the voltage Voled of the OLED that emits light.

According to an embodiment of the present invention, the influence of the voltage of the OLED on the amount of current flowing through the OLED is removed when the OLED emits the light, and thus influences of the voltage variation due to the voltage drop of the second power source ELVSS, the variation in characteristics of the OLED, the change in the current-voltage characteristics due to temperature, and the deterioration of the OLED, on the light emission may be minimized or reduced.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A pixel circuit of an organic light emitting display, the pixel circuit comprising:
a second N-channel metal oxide semiconductor (NMOS) transistor coupled to a data line and a scan line, the second NMOS transistor being for supplying data signals to a first node;
a storage capacitor having a first terminal coupled to the first node and a second terminal coupled to a second node;
an organic light emitting diode (OLED) having a first terminal coupled to the second node and a second terminal coupled to a second power source;
a first NMOS transistor comprising a first electrode, a second electrode, and a gate electrode coupled to the first node, and for supplying a current corresponding to a voltage applied to the first node from a first power source to the second power source via the OLED; and
a third NMOS transistor coupled to the first NMOS transistor in series and configured to be turned on when a light emission control signal is supplied from a light emission control line.

2. The pixel circuit of claim 1, wherein the first electrode of the first NMOS transistor is a drain electrode and the second electrode of the first NMOS transistor is a source electrode, and the second electrode of the first NMOS transistor is coupled to the second node.

3. The pixel circuit of claim 1, wherein the third NMOS transistor comprises:
a gate electrode coupled to the light emission control line;
a first electrode coupled to the first power source; and
a second electrode coupled to the first electrode of the first NMOS transistor.

4. The pixel circuit of claim 1, wherein the third NMOS transistor comprises:
a gate electrode coupled to the light emission control line;
a first electrode coupled to the second electrode of the first NMOS transistor; and
a second electrode coupled to the second node.

5. The pixel circuit of claim 1, wherein the second NMOS transistor is configured to be turned on when a scan signal is supplied from the scan line.

6. The pixel circuit of claim 1, further comprising a third power source for applying a reference voltage to the second node.

7. The pixel circuit of claim 1, wherein the first power source is configured to supply a first voltage, and the second power source is configured to supply a second voltage that is lower than the first voltage.

8. An organic light emitting display apparatus comprising:
a first scan driver coupled to light emission control lines for supplying light emission control signals;
a second scan driver coupled to scan lines for supplying scan signals;
a data driver coupled to data lines for supplying data signals; and
a display unit comprising a plurality of pixel circuits coupled to the scan lines, the light emission control lines, and the data lines,
wherein each of the pixel circuits comprises:
a second N-channel metal oxide semiconductor (NMOS) transistor for supplying a corresponding one of the data signals to a first node, the second NMOS transistor coupled to a corresponding one of the data lines and a corresponding one of the scan lines;
a storage capacitor having a first terminal coupled to the first node and a second terminal coupled to a second node;
an organic light emitting diode (OLED) having a first terminal coupled to the second node and a second terminal coupled to a second power source;
a first NMOS transistor comprising a first electrode, a second electrode, and a gate electrode coupled to the first node, and for supplying a current corresponding to a voltage applied to the first node from a first power source to the second power source via the OLED; and
a third NMOS transistor coupled to the first NMOS transistor in series and configured to be turned on when a corresponding one of the light emission control signals is supplied from a corresponding one of the light emission control lines.

9. The organic light emitting display apparatus of claim 8, wherein the first electrode of the first NMOS transistor is a drain electrode and the second electrode of the first NMOS transistor is a source electrode, and the second electrode of the first NMOS transistor is coupled to the second node.

10. The organic light emitting display apparatus of claim 8, wherein the third NMOS transistor comprises:
a gate electrode coupled to the corresponding light emission control line;
a first electrode coupled to the first power source; and
a second electrode coupled to the first electrode of the first NMOS transistor.

11. The organic light emitting display apparatus of claim 8, wherein the third NMOS transistor comprises:
a gate electrode coupled to the corresponding one of the light emission control lines;
a first electrode coupled to the second electrode of the first NMOS transistor; and
a second electrode coupled to the second node.

12. The organic light emitting display apparatus of claim 8, wherein the second NMOS transistor is configured to be turned on when a corresponding one of the scan signals is supplied from a corresponding one of the scan lines.

13. The organic light emitting display apparatus of claim 8, further comprising a third power source for applying a reference voltage to the second node.

14. The organic light emitting display apparatus of claim 8, wherein the first power source is configured to apply a first voltage, and the second power source is configured to apply a second voltage that is lower than the first voltage.
